(19) United States
(12) Patent Application Publication
(10) Pub. No.: US 2010/0314408 A1
(43) Pub. Date: Dec. 16, 2010

(54) METHOD AND APPARATUS FOR SANITARY DISPENSING OF HOLY WATER FROM A CROSS-SHAPED FIXTURE

(76) Inventor: John M. Hartel, Bayside, NY (US)

Correspondence Address: Keusey & Associates, P.C., 420 Jericho Tpke., Suite 324, Jericho, NY, 11753, US

(21) Appl. No.: 12/482,917

(22) Filed: Jun. 11, 2009

(51) Int. Cl. B67D 1/00; B05B 11/00; B67D 7/06; B65D 37/00; G04C 23/00

(52) U.S. Cl. 222/52; 222/78; 222/642; 222/181.3; 222/214

(57) ABSTRACT

An apparatus for sanitary dispensing of holy water including a cross-shaped housing having one or more compartments. A front support plate and lower sensor/dispenser plate assembly form an L-shaped support bracket. A refillable contain, a micro pump and a dispenser nozzle are stacked on the support bracket. The support bracket pivots from a closed position, to an outwardly angled open position to facilitate refilling of the container.

### BACKGROUND OF THE INVENTION

1. Field of the Invention

The present invention relates to an apparatus for sanitary dispensing of holy water from a refillable, decorative, cross-shaped fixture.

2. The Prior Art

Currently many churches, parochial schools and related institutions have dishes of holy water at various locations. Some of these locations are accessible by large numbers of people. Other locations are accessible to the general public. A concern exists that communicable diseases, like the flu, can be transmitted at these wet locations because hundreds or thousands of hands may be in contact with tile dish, the water, or nearby counter areas. Another concern relates to intentional contamination of the open water dish.

In a different sanitary application, automatic soap dispensers have been developed for placement in public restrooms. These dispensers are typically wall mounted and provide a sensor for detecting proximity of a user's hand. U.S. Pat. No. 5,255,822 entitled Automatic Soap Dispenser and U.S. Pat. No. 4,722,372 entitled Electrically Operated Dispensing Apparatus and Disposable Container Usable Therewith both have portions of the housing extending below the sensor. These housing portions can easily contact the user's hand while trying to activate the sensor, thereby defeating the whole point of having a sanitary dispenser.

U.S. Pat. No. 6,390,329 entitled Apparatus for Hands-Free Dispensing of a Measured Quantity of Material has a more streamlined design, but still provides an exposed hinge 20 below the dispenser, and immediately adjacent the dispenser nozzle 34 and opening 38. The opening and hinge serve as surfaces where soap can accumulate over time. Even worse, if a user places their hand too close to the opening, soap can splash off their hand and contact the opening or the hinge.

All three of the cited patents utilize disposable canisters of soap which are mounted on the fixed housing, near the mounting wall. When a soap canister is empty, it is removed and thrown away. A new canister is then installed into the dispenser. Because of constant canister changes, and the weight of fill canisters, the canister needs to be securely supported. Therefore, canisters are not installed on the pivoting covers.

Accordingly, it would be desirable to provide a method and apparatus for sanitary dispensing of holy water from a refillable fixture. In addition, it would be desirable to place the container on the pivoting cover to allow easy access during refilling.

### SUMMARY OF THE INVENTION

Accordingly, it is an object of the present invention to provide a sanitary dispenser for holy water.

It is a further object of the present invention to provide a fluid dispenser with a refillable container.

It is another object to provide a flat, closed lower sensor/dispenser plate to avoid downwardly extending surfaces which can lead to cross-contamination.

These and other related objects are achieved according to an embodiment of the invention by an apparatus for sanitary dispensing of holy water having a cross-shaped housing with a vertical compartment. A front support plate is provided for selectively moving between a closed state in which the vertical compartment is covered and an open state in which the vertical compartment is exposed. A lower sensor/dispenser plate assembly includes a pivoting connection to the housing, a rigid connection to the front support plate, a sensor, and a dispenser nozzle. A refillable container is attached to the front support plate and is in fluid communication with the dispenser nozzle. The refillable container is disposed within the vertical compartment when the front support plate is in the closed state, and the refillable container is rotated out away from the vertical compartment when the front support plate is pivoted to the open state so that holy water can be easily added to the refillable container.

The vertical compartment has a back side for mounting to a wall and is open on the front side and bottom. The front support plate and the lower sensor/dispenser plate assembly form an L-shaped bracket which rotates around the pivoting connection between the lower sensor/dispenser plate and the housing. The L-shaped bracket is configured and designed to fit across the open front side and bottom of said housing.

The housing further includes at least one side compartment, and a sensor circuit disposed within one of the compartments. The sensor circuit includes a sensitivity adjustment to control sensor operation.

A micro pump is disposed between said refillable container and the nozzle. A pump controller is disposed within one of the compartments and is electrically coupled between said sensor circuit and the micro pump. The sensor circuit transmits an activation signal to the pump controller. The pump controller includes an adjustment to control the amount of time for which the micro pump will operate in response to the pump controller receiving an activation signal. A battery is disposed within one of the compartments. The side compartments are walled off from the vertical compartment, and the battery is disposed within one of the side compartments to maintain it separate from the container, with the battery leads passing through an aperture in the wall.

A cross-shaped front panel having a vertical section and two arms is provided. The vertical section is secured to the front support plate. In the closed state, the cross-shaped front panel completely overlies the housing. The sensor operates on reflected light, and no portion of the apparatus is disposed below the sensor/dispenser plate. The vertical compartment is generally rectangular in shape and has an open front side and an open bottom. The open front and open bottom have an opening width of dimension X. The front support plate and the lower sensor/dispenser plate assembly form a rigid L-shaped bracket which is configured and dimensioned to extend across the open front side and open bottom of the vertical compartment and form a closed rectangular cube. The front support plate and the lower sensor/dispenser plate have a width of dimension Y, which is less than dimension X. The vertical compartment is provided with a chamfer to accommodate the container when the front support plate is pivoted into its closed position. The L-shaped bracket supports a stacked assembly including a micro pump disposed in between the refillable container and the dispenser nozzle. A cross-shaped front panel is provided, wherein said refillable container is permanently attached to the front support plate, and wherein the front support plate is disposed between the container and the cross-shaped front panel.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1 is a front view of a sanitary dispenser according to an embodiment of the invention.

FIG. 2 is an exploded view of the dispenser housing with the front plate removed.

FIG. 3 is a side elevational view of the front plate.

FIG. 4 is a side elevational view of the dispenser illustrating a refilling operation.

### DETAILED DESCRIPTION OF THE PREFERRED EMBODIMENTS

In general, the apparatus according to the invention provides a device for sanitary dispensing of holy water. More particularly, it includes a housing with a vertical compartment that is suited for mounting on a post or wall. A front support plate is pivotally mounted at its lower end to the housing. Disposed behind the support plate is a container which gravity feeds a micro pump. Below the micro pump is a sensor/dispenser assembly which senses the presence of a hand and activates the micro pump. A dispenser nozzle disposed adjacent the sensor delivers a predetermined dosage of several drops of holy water. The sensor/dispenser plate forms a generally flat bottom surface to the device. Accordingly, there are no downwardly extending parts or surfaces to contact a user's hand which minimizes the possibility of cross-contamination from one user to the next.

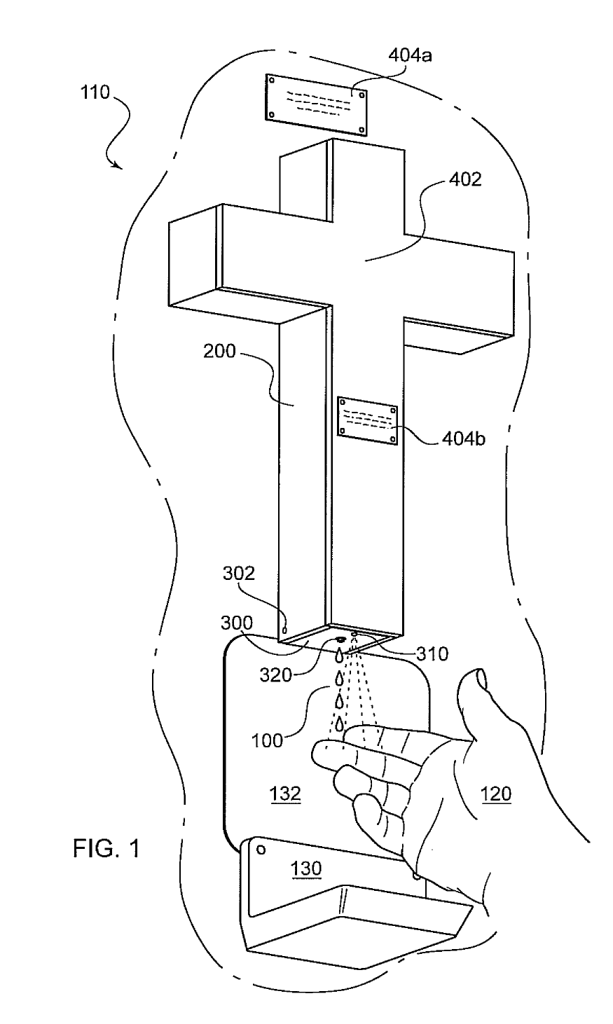

Referring now in detail to the invention, and in particular to FIG. 1, there is shown a sanitary dispenser 110. Dispenser 110 may be mounted to a post or wall, several feet above the ground. Visually, the user is presented with a cross-shaped front panel 402. Panel 402 is decorative in nature and can be made from a variety of materials like wood, metal, plastic, or fabric. A plaque, for example, a dedication plaque 404a may be displayed adjacent dispenser 110 or on panel 402, as shown by plaque 404b. Panel 402 completely covers the underlying housing 200. In a preferred embodiment, housing 200 is a cross-shaped housing and front panel 402 is a correspondingly sized and dimensioned cross-shape. By making front panel 402 slightly wider and taller than housing 200, the housing can be completely obscured from viewers facing the dispenser head on. When viewed from an angle, or on the side, housing 200 will be visible. Housing 200 is a hollow box with several compartments where the dispenser components are stowed. Housing 200 can be fabricated from a variety of materials including wood, metal or plastic. In one embodiment, housing 200 is made from rectangular panels of ¼ inch thick aluminum plate. The exterior may consist of brushed metal, or may be painted or otherwise finished to provide a neutral appearance.

At the very bottom of dispenser 110 is a flat sensor/dispenser plate 300. Plate 300 functions as a closed, finished bottom surface to dispenser 110. Accordingly, there are no other downwardly extending surfaces which can become wet or otherwise act as contact areas for the transmission of contaminants. Well below the dispenser, there may be provided a catch basin 130 to contain stray drops of dispensed fluid. However, the catch basin will be placed low enough so that a user's hand 120 would ordinarily not have occasion for accidental contact therewith. In use, a user's hand 120 is moved into position below sanitary dispenser 110. A sensor 300 detects the drop in ambient light due to the presence of the hand. Within about 1 second, several drops of holy water 100 are dispensed from nozzle 320. The user then withdraws their hand and departs. Any stray drop of fluid remaining in the nozzle and which may drip out subsequently can be caught in catch basin 130. Catch basin 130 may be fashioned as a small sink, with a drain leading to a locked waste bin, or to a building waste line. In this manner, there will not be any standing water in the catch basin. A back splash 132 may be provided to protect the wall or other surface from moisture. For example, back splash 132 may consist of a stainless steel sheet secured to the wall, which can be easily cleaned and sanitized.

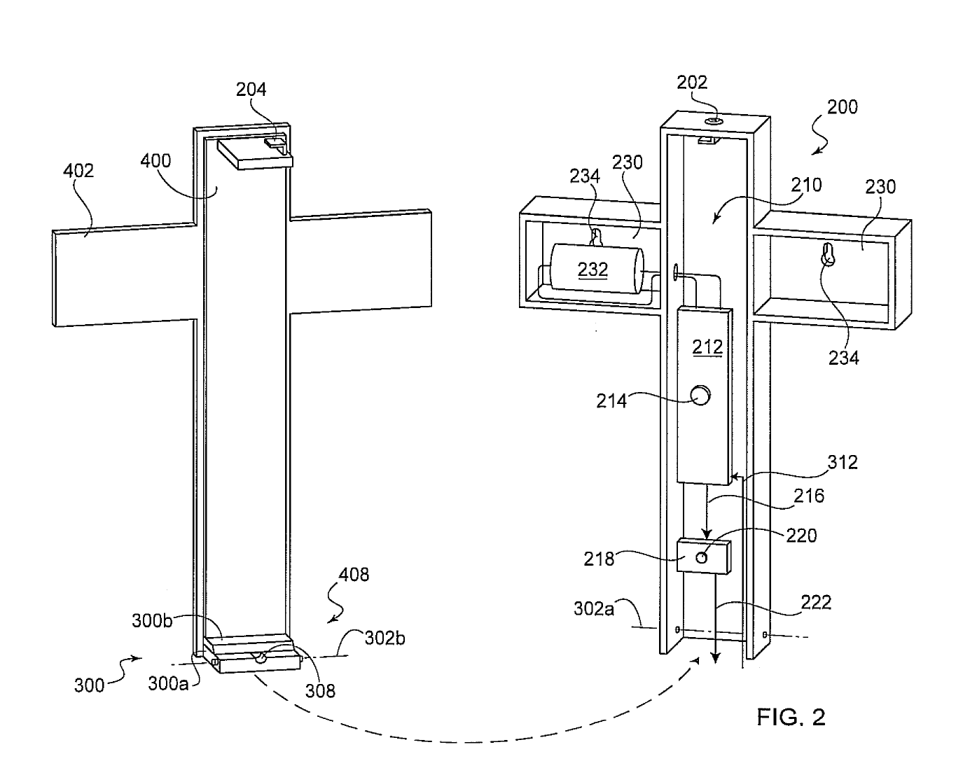

Referring now to FIG. 2, there is shown the sanitary dispenser with front panel 402 removed in an exploded view to illustrate the details and inner workings of housing 200. A vertical compartment 210 has four closed walls, and a lock 202 in one of the top or side walls. A hasp 204 is provided at the top of front support panel 400 for engagement with the lock. The front and bottom portions of vertical compartment 210 are open. A front plate support 400 and sensor/dispenser plate 300 form an L-shaped bracket 408 which attached to the open bottom end of vertical compartment 210 via a pivot axis 302a and 302b, generally referred to as pivoting connection 302. When completely assembled, the L-shaped bracket 408 serves as the fifth and sixth side of vertical compartment 210, whereby housing 200 can be secured and locked with the various components safely inside.

On either side of vertical compartment 210, there may be provided one or two optional horizontal compartments 230. Horizontal compartments are useful for providing mounting holes, keyholes 234, or other mounting hardware, for installing the dispenser on a wall or post. If configured as open compartments, the horizontal compartments may be used to house a battery 232, battery pack, or other power source. As can be appreciated, the separation of the horizontal compartments from the vertical compartments helps to insure that the power source remains dry. In addition, if a battery corrodes, it is isolated from the remaining components. In other words, there are no other components stowed below the battery. Batter leads may pass through an aperture in the wall separating vertical compartment 210 from horizontal compartments 230. A rubber grommet may be provided to protect the leads from contacting the metal surfaces of the aperture.

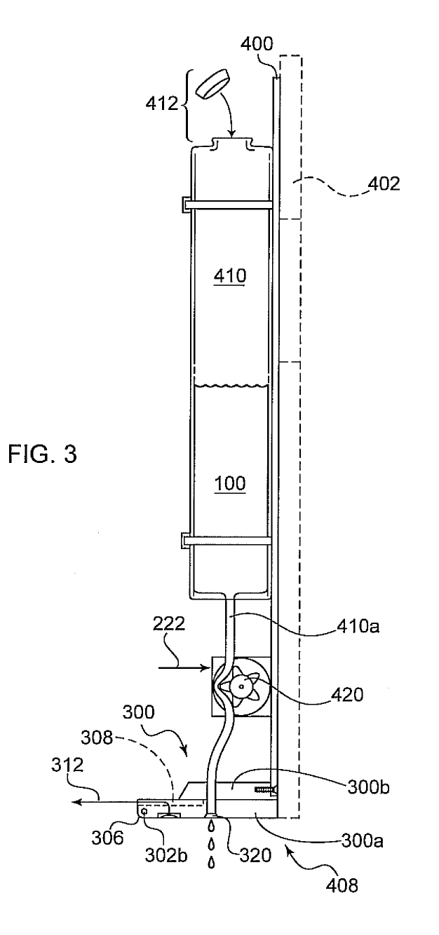

The battery pack is used to power a sensor circuit 212 and a pump controller 218, which are disposed within the vertical compartment in the illustration. Circuit 212 and controller 218 may be disposed in the second horizontal compartment 230. When completely assembled, a sensor sends a sensor signal 312 to sensor circuit 212. A sensitivity control is provided to adjust the threshold for the sensor signal. For example, how much of a decrease in ambient light is required to generate a sensor signal. If the threshold is exceeded, sensor circuit 212 transmits a dispense signal 216 to pump controller 218. Pump controller, and micro pump 420 (of FIG. 3) are also both powered by battery pack 232. An adjustment 220 is provided to adjust the duration of a pump activation signal 222. The pump activation signal 222 then transmits to micro pump 420 a signal to operate the micro pump for 1 to 3 seconds.

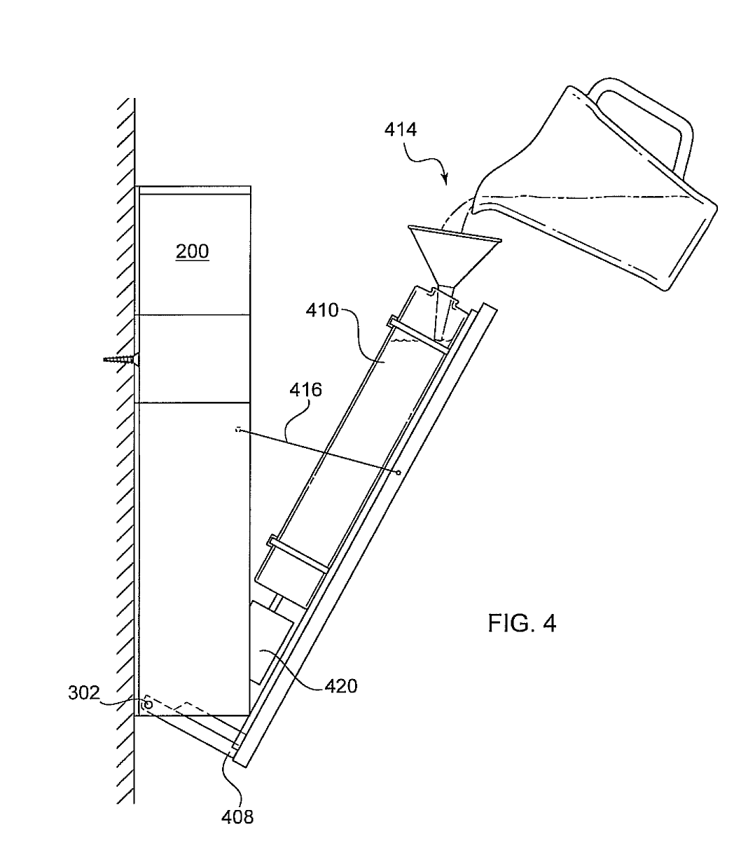

A detailed view of L-shaped bracket 408 is shown in FIG. 3. The pivot axis 302b is shown in the bottom left corner of sensor/dispenser plate 300. A rounded or radius corner 306 allows L-shaped bracket 408 to fit closely against the back wall of vertical compartment 210, yet rotate clockwise as shown in FIG. 4. The pivoting connection 302 is formed by drilling a hole through the side walls of vertical compartment 210 and also through sensor/dispenser plate 300 along pivot axis 302a/302b. One or two pins are force fit into the drilled holes forming a pivot axle. Sensor/dispenser plate 300 is formed from a lower plate 300a having a channel 308 formed along the top surface thereof. After installing sensor 310, the wires are routed through channel 308 where they have a degree of freedom to move upwardly away from the back wall of vertical compartment 210 when the L-shaped bracket is closing, i.e. pivoting counter-clockwise in the view of FIG. 4.

The next step in completing the sensor/dispenser plate assembly 300 is attaching an upper plate 300b. Upper plate 300b covers the sensor 310 at its left side. On the right side the upper plate 300b is recessed rearwardly from lower plate 300a to form a lip which receives front support plate 400. Support plate is secured with screws or other suitable fastening means to top plate 300b, thereby forming the rigid connection 304. An aperture is formed through sensor/dispenser plate 300 and a tube 410a is installed to communicate fluid to a dispenser nozzle 320.

From top to bottom along front support plate 400, there is installed a container 410. At the upper end, there is a cap and opening 412 to perform a refilling operation, as shown in FIG. 4. The lower end of container 410 is connected to a tube 410 which communicates fluid through a micro pump 420 to dispenser nozzle 320. In order to avoid building up a vacuum as fluid 100 is pumped out of container 410, the cap 412 is provided with a small air vent. As mentioned earlier, battery pack 232 is used to power micro pump 420. Pump controller sends an activation signal 222, which runs the pumps for several seconds, for example, between 1-3 seconds. The duration can be preset by the user with adjustment 222 that is provided as part of the pump controller 218. During micro pump operation, several cams rotate past tube 410a, alternately squeezing small section of tubing closed. The tube naturally fills with water under the influence of gravity. The counter-clockwise motion of the cams allows small quantities of water to pass out of the micro pump which are forced through the nozzle under slight pressure. The number and spacing of cams, insures that at least one will always be present to close off the tube, and prevent fluid from just running out.

In a preferred embodiment, fluid 100 is holy water. In most automatic dispensers, the containers are disposable. Our design avoids this wasteful practice by providing a refillable container. To protect the electronics from moisture, the L-shaped bracket 408 pivots clockwise, out of the housing, as shown in FIG. 4. A limiting chain or cord 416 holds L-shaped bracket at a predetermined angle, based on the height and location of the installation. The cap is removed from the opening and a funnel or other suitable device like a watering can with a long thin pouring spout, is used to refill 414 container 410. If liquid spills, it will naturally fall down in a direction away from housing 200. After the container is filled, the cap is replaced and the front support plate is rotated counter-clockwise to close the housing. Lock 202 is turned and the key removed. As can be seen in FIG. 2, the inner side walls of vertical compartment 210 may be provided with a chamfer 210a, to accommodate the width of container 410. In the embodiment shown, the apparatus is not connected to an exterior power source. The apparatus is not plumbed, nor is it connected to a building waste line.

The apparatus may be used to practice a method of sanitary dispensing of holy water. The apparatus is mounted to a wall or post. The key is used to unlock the lock. The front support plate is pivoted outwardly until it is stopped by a retaining member. The cap is removed and the container is filled with holy water. The cap is replaced and the sensitivity control and pump controller are adjusted. The front panel is pivoted closed, locked and the key is removed. A user places their hand in operative distance to the sensor, which causes the sensor circuit to transmit a dispense signal to the pump controller. The pump controller transmits a pump activation signal for a preset period of time. The micro pump with is mounted on the pivoting front support plate runs for a few seconds and dispenses holy water through the dispenser nozzle. After numerous uses, the process for unlocking, refilling and locking is repeated.

Having described various methods, apparatus, and systems (which are intended to be illustrative and not limiting), it is noted that modifications and variations can be made by persons skilled in the art in light of the above teachings. For example, the batter and electronics can be arranged in several ways in the various compartments. The sensor circuit and pump controller may be configured as one device. The adjustments can be factory preset, or settable by the user either through analog or digital means. It is therefore to be understood that changes may be made in the particular embodiments of the invention disclosed which are within the scope and spirit of the invention.

What is claimed is:

1. An apparatus for sanitary dispensing of holy water comprising:
a cross-shaped housing having a vertical compartment;
a front support plate for selectively moving between a closed state in which the vertical compartment is covered and an open state in which the vertical compartment is exposed;
a lower sensor/dispenser plate assembly comprising (i) a pivoting connection to the housing, (ii) a rigid connection to said front support plate, (iii) a sensor, and (iv) a dispenser nozzle; and
a refillable container attached to said front support plate and in fluid communication with said dispenser nozzle;
wherein said refillable container is disposed within said vertical compartment when said front support plate is in the closed state, and wherein said refillable container is rotated out away from said vertical compartment when said front support plate is pivoted to the open state so that holy water can be easily added to the refillable container.

2. The apparatus of claim 1, wherein said vertical compartment has a back side for mounting to a wall and is open on the front side and bottom; wherein said front support plate and said lower sensor/dispenser plate assembly form an L-shaped bracket which rotates around the pivoting connection between the lower sensor/dispenser plate and said housing; and wherein said L-shaped bracket is configured and designed to fit across the open front side and bottom of said housing.

3. The apparatus of claim 2, wherein said housing further includes at least one side compartment, and wherein said apparatus further comprises a sensor circuit disposed within one of the compartments and electrically coupled to said sensor, wherein said sensor circuit includes a sensitivity adjustment to control sensor operation.

4. The apparatus of claim 3, further comprising a micro pump disposed between said refillable container and said nozzle; and a pump controller disposed within one of the compartments and electrically coupled between said sensor circuit and said micro pump, wherein said sensor circuit transmits an activation signal to said pump controller.

5. The apparatus of claim 4, wherein said pump controller includes an adjustment to control the amount of time for which the micro pump will operate in response to said pump controller receiving an activation signal.

6. The apparatus of claim 5, further comprising a battery disposed within one of the compartments.

7. The apparatus of claim 6, wherein the side compartments are walled off from the vertical compartment, and wherein the battery is disposed within one of the side compartments to maintain it separate from the container, and wherein the battery leads pass through an aperture in the wall.

8. The apparatus of claim 7, further including a cross-shaped front panel having a vertical section and two arms, wherein the vertical section is secured to said front support plate, and wherein in the closed state, the cross-shaped front panel completely overlies the housing.

9. The apparatus of claim 8, wherein said sensor operates on reflected light, and wherein no portion of the apparatus is disposed below said sensor/dispenser plate.

10. The apparatus of claim 1, wherein said vertical compartment is generally rectangular in shape and has an open front side and an open bottom, wherein the open front and open bottom have an opening width of dimension X.

11. The apparatus of claim 10, wherein said front support plate and said lower sensor/dispenser plate assembly form a rigid L-shaped bracket which is configured and dimensioned to extend across the open front side and open bottom of said vertical compartment and form a closed rectangular cube.

12. The apparatus of claim 11, wherein said front support plate and said lower sensor/dispenser plate have a width of dimension Y, which is less than dimension X.

13. The apparatus of claim 12, wherein the vertical compartment is provided with a chamfer to accommodate the container when the front support plate is pivoted into its closed position.

14. The apparatus of claim 13, further comprising a micro pump, wherein said L-shaped bracket supports a stacked assembly comprising said micro pump disposed in between said refillable container and said dispenser nozzle.

15. The apparatus of claim 14, further comprising a cross-shaped front panel, wherein said refillable container is permanently attached to said front support plate, and wherein said front support plate is disposed between said container and said cross-shaped front panel.
